(19) United States
(12) Patent Application Publication
(10) Pub. No.: US 2015/0102517 A1
(43) Pub. Date: Apr. 16, 2015

(54) METAL MOLD FOR CARBON FIBER REINFORCED PLASTIC COMPONENT AND METHOD OF MANUFACTURING CARBON FIBER REINFORCED PLASTIC COMPONENT

(71) Applicant: YAMASEI CORPORATION, Ehime (JP)

(72) Inventor: Masaya Takeda, Ehime (JP)

(73) Assignee: YAMASEI CORPORATION, Ehime (JP)

(21) Appl. No.: 14/402,621

(22) PCT Filed: Nov. 16, 2012
(86) PCT No.: PCT/JP2012/079795

§ 371 Date: Nov. 20, 2014

(30) Foreign Application Priority Data
May 22, 2012 (JP) 2012-116661

(51) Int. Cl. B29C 43/36

(52) U.S. Cl. CPC B29C 43/361; B29C 2043/3615; B29K 2101/12
USPC 264/163; 425/218

(57) ABSTRACT

To easily cut CFRP, a metal mold for CFRP component includes a stationary blade that stands still in contact with one surface of a CFRP material made of a carbon fiber reinforced plastic, and a moving blade arranged at a moving blade surface side of the CFRP material, the moving blade surface being a surface at an opposite side to a stationary blade surface, the stationary blade surface being a surface of a side where the stationary blade is positioned, and adapted to cut the CFRP material by being moved from the moving blade surface side to the stationary blade surface side and providing shear force to the CFRP material together with the stationary blade.

### FIELD

The present invention relates to a metal mold for carbon fiber reinforced plastic component, and a method of manufacturing a carbon fiber reinforced plastic component.

### BACKGROUND

In recent years, there are some structural members of aircrafts, automobiles, and the like using so-called carbon fiber reinforced plastic (CFRP) that is a light composite member having high strength. The CFRP is a composite member using a synthetic resin for a parent material and carbon fiber for a reinforcing member, and is often used as a structural member in various fields that require lightness and strength, such as golf clubs.

However, since the CFRP has high strength, and processing at the time of manufacturing is difficult, there are some cases where the processing is performed with a technique different from metal materials, and the like, in manufacturing a structural body using conventional CFRP. For example, in a laser processing method of a composite material described in Patent Literature 1, cutting of the CFRP with a laser or water jet is disclosed.

### CITATION LIST

### Patent Literature

### Patent Literature 1: Japanese Laid-open Patent Publication No. 2011-56583

### SUMMARY

### Technical Problem

However, when cutting the CFRP using a laser or water jet, it takes a long time from start to completion of cutting work because the member is cut into a desired shape while a laser light beam or water jet is hit on the member in a spotted manner. Therefore, it is difficult to cut a large volume of CFRP within a short time, and it is extremely difficult to mass produce members using the CFRP. In addition, since mass production of the members using the CFRP is difficult, the difficulty in cutting is lead to an increase in production cost.

The present invention has been made in view of the foregoing, and an objective is to provide a metal mold for carbon fiber reinforced plastic component and a method of manufacturing a carbon fiber reinforced plastic component that enable easy cutting of CFRP.

### Solution to Problem

To solve the above problem and achieve the above objective, a metal mold for a carbon fiber reinforced plastic component according to the present invention includes a stationary blade that is a blade standing still in contact with one surface of a material to be processed made of a carbon fiber reinforced plastic; and a moving blade arranged at a moving blade surface side of the material to be processed, the moving blade surface being a surface opposite to a stationary blade surface, the stationary blade surface being a surface at a side where the stationary blade is positioned, and adapted to cut the material to be processed by being moved from the moving blade surface side to the stationary blade surface side and providing shear force to the material to be processed together with the stationary blade.

In the metal mold for the carbon fiber reinforced plastic component, it is preferable that an inclined angle of a blade part of the moving blade, the blade part being in contact with the material to be processed, in a moving direction of the moving blade with respect to the moving blade surface is less than 10°

In the metal mold for the carbon fiber reinforced plastic component, it is preferable that a distance from the moving blade to the stationary blade in a direction perpendicular to a moving direction falls within a range from 0.025 to 0.075 mm, both exclusive.

In the metal mold for the carbon fiber reinforced plastic component, it is preferable that the metal mold for the carbon fiber reinforced plastic component further includes a heating means adapted to heat the material to be processed and raise a temperature of a cut portion in the material to be processed.

In the metal mold for the carbon fiber reinforced plastic component, it is preferable that at the time the carbon fiber reinforced plastic is a thermosetting resin, the heating means heats the cut portion in the material to be processed to be within a temperature range including a temperature of a glass transition point of the thermosetting resin, and in which a physical property of the material to be processed becomes to have a suitable value for heating.

In the metal mold for the carbon fiber reinforced plastic component, it is preferable that the metal mold for the carbon fiber reinforced plastic component further includes a pressing means adapted to provide pressing force in a moving direction of the moving blade to the material to be processed, wherein the pressing means provides the pressing force to the material to be processed at a time of cutting the material to be processed within a range from 3 to 10 MPa, both inclusive.

In the metal mold for the carbon fiber reinforced plastic component, it is preferable that the metal mold for the carbon fiber reinforced plastic component further includes a molding part adapted to mold the material to be processed by providing the pressing force to the material to be processed, wherein, after the material to be processed is molded by the molding part, the moving blade cuts the material to be processed together with the stationary blade.

Further, to solve the above problem and achieve the above objective, a method of manufacturing a carbon fiber reinforced plastic component according to the present invention includes cutting a material to be processed made of a carbon fiber reinforced plastic by providing shear force to the material to be processed in a thickness direction.

In the method of manufacturing the carbon fiber reinforced plastic component, it is preferable that the cutting of the material to be processed is performed using a blade having an inclined angle in a direction providing the shear force, with respect to a surface of the material to be processed, being less than 10°.

In the method of manufacturing the carbon fiber reinforced plastic component, it is preferable that the cutting of the material to be processed is performed using a pair of blades, the pair of blades being respectively arranged at both sides of the material to be processed in a thickness direction, and having a distance in a direction perpendicular to a direction providing the shear force to the material to be processed fall within a range from 0.025 to 0.075 mm, both exclusive.

In the method of manufacturing the carbon fiber reinforced plastic component, it is preferable that the method further includes a process of heating the material to be processed to increase a temperature of a cut portion in the material to be processed.

In the method of manufacturing the carbon fiber reinforced plastic component, it is preferable that at the time the carbon fiber reinforced plastic is a thermosetting resin, the cutting of the material to be processed is performed in a state where the temperature of the cut portion in the material to be processed is increased to be within a temperature range including a temperature of a glass transition point of the thermosetting resin, and in which a physical property of the material to be processed becomes to have a suitable value for heating.

In the method of manufacturing the carbon fiber reinforced plastic component, it is preferable that the cutting of the material to be processed is performed by providing the pressing force to the material to be processed in a direction of providing the shear force within a range from 3 to 10 MPa, both inclusive.

In the method of manufacturing the carbon fiber reinforced plastic component, it is preferable that the method further includes a process of molding the material to be processed by providing the pressing force to the material to be processed, wherein, after the material to be processed is molded, the cutting of the material to be processed is performed by a metal mold that has molded the material to be processed.

### Advantageous Effects of Invention

The metal mold for carbon fiber reinforced plastic component and the method of manufacturing a carbon fiber reinforced plastic component of the present invention have an effect to easily cut CFRP.

### BRIEF DESCRIPTION OF DRAWINGS

FIG. 1 is a schematic diagram of a metal mold for carbon fiber reinforced plastic component according to a first embodiment.

FIG. 2 is a detailed diagram of an A part of FIG. 1.

FIG. 3 is a detailed diagram of a B part of FIG. 1.

FIG. 4 is a C-C arrow view of FIG. 2.

FIG. 5 is a D-D arrow view of FIG. 3.

FIG. 6 is an explanatory diagram about a result of a test about a blade edge state of a moving blade.

FIG. 7 is an explanatory diagram about conditions of test about a cut state with respect to a clearance.

FIG. 8 is an explanatory diagram about an evaluation result of a cut state test with respect to pressing force.

FIG. 9 is an explanatory diagram illustrating a state of when a CFRP material is cut with a metal mold illustrated in FIG. 1.

FIG. 10 is an explanatory diagram illustrating a state at the time of start of cutting the CFRP material illustrated in FIG. 9.

FIG. 11 is an explanatory diagram illustrating a state in which pressing force is given to the CFRP material illustrated in FIG. 10 with a pressing part.

FIG. 12 is an explanatory diagram illustrating a state in which the CFRP material illustrated in FIG. 11 is cut.

FIG. 13 is an explanatory diagram of when a CFRP component after cutting is taken out.

FIG. 14 is a schematic diagram of a metal mold for carbon fiber reinforced plastic component according to a second embodiment.

FIG. 15 is a simplified diagram of a sample when a test of a cut state with respect to temperature is performed.

FIG. 16 is an explanatory diagram about conditions of a cut state test with respect to temperature.

FIG. 17 is an explanatory diagram about a quality test of a cut state with respect to temperature change in the vicinity of a glass transition point.

FIG. 18 is an explanatory diagram about a cutting temperature range at the time of cutting a CFRP material.

FIG. 19 is an explanatory diagram of before a CFRP material is molded with the metal mold illustrated in FIG. 14.

FIG. 20 is an explanatory diagram of when the CFRP material illustrated in FIG. 19 is molded.

FIG. 21 is an explanatory diagram at the time of molding of the CFRP material illustrated in FIG. 20.

FIG. 22 is an explanatory diagram illustrating a state in which the lower mold row material holding part illustrated in FIG. 21 is lowered.

FIG. 23 is an explanatory diagram illustrating a state in which the CFRP material illustrated in FIG. 22 is cut.

FIG. 24 is an explanatory diagram of when a CFRP component after cutting is taken out.

FIG. 25 is a plan view of a moving blade in a modification of a metal mold according to the first embodiment.

FIG. 26 is an explanatory diagram illustrating a modification of the moving blade of FIG. 25.

FIG. 27 is an explanatory diagram of a relative angle of a CFRP material and a moving blade in a modification of the metal mold according to the first embodiment.

### DESCRIPTION OF EMBODIMENTS

Hereinafter, embodiments of a metal mold for carbon fiber reinforced plastic component and a method of manufacturing a carbon fiber reinforced plastic component according to the present invention will be described in detail with reference to the drawings. Note that the present invention is not limited by the embodiments. Further, configuration elements in the following embodiments include easy and replaceable things for a person skilled in the art and substantially equivalent things.

### First Embodiment

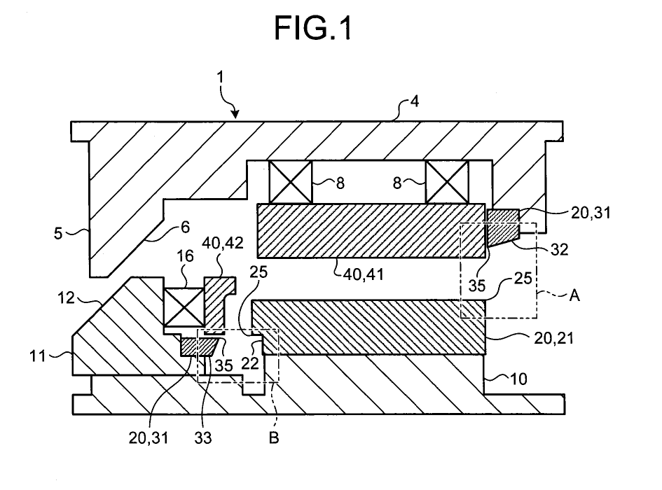

FIG. 1 is a schematic diagram of a metal mold for carbon fiber reinforced plastic component according to a first embodiment. Note that, in the following description, an upper side of a metal mold 1 according to the first embodiment in a normal use state is an upper side, and a lower side of the metal mold 1 in the normal use state is a lower side. The metal mold 1 illustrated in FIG. 1 is a principal part of a device used in manufacturing a component made of a carbon fiber reinforced plastic (CFRP), and includes an upper mold 4 arranged at a relatively upper side, and a lower mold 10 arranged relatively below the upper mold 4.

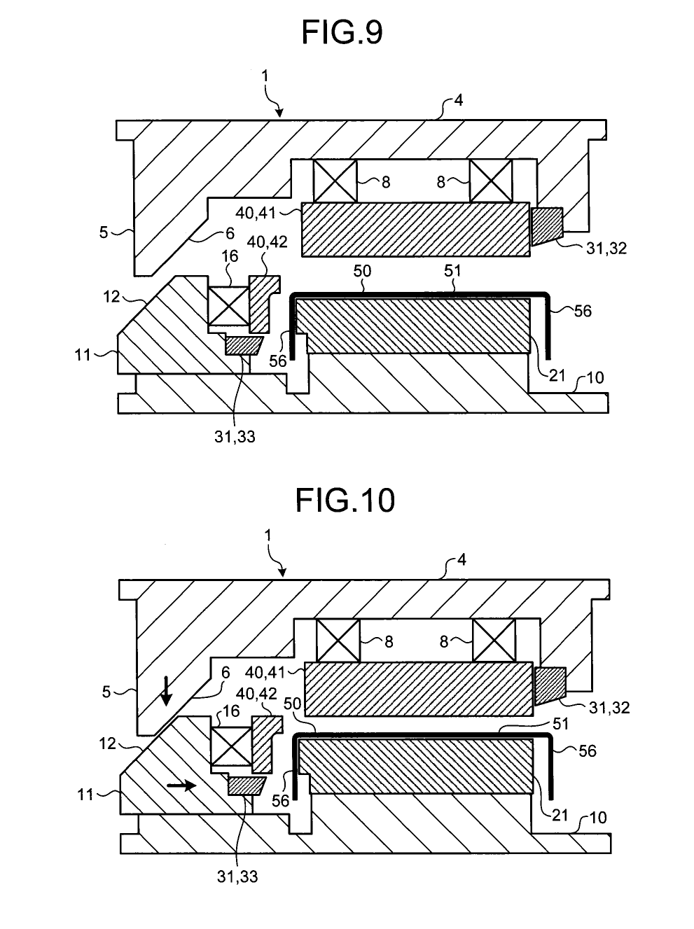

The metal mold 1 is provided with a cutting mechanism 20 including a stationary blade 21 and moving blades 31, and the metal mold 1 can cut, with the cutting mechanism 20, a predetermined portion of a CFRP material 50 (see FIG. 9) that is a material to be processed made of CFRP. In the cutting mechanism 20, between the stationary blade 21 and the moving blades 31, the stationary blade 21 is provided to the lower mold 10, and the moving blades 31 are provided to the upper mold 4 and the lower mold 10. In the cutting mechanism 20, the upper mold 4 approaches the lower mold 10 from a state where the upper mold 4 and the lower mold 10 are separated, so that the moving blades 31 are moved in a direction approaching the stationary blade 21 with the movement of the upper mold 4, and the CFRP material 50 can be cut with the moving blades 31 and the stationary blade 21.

To be specific, the stationary blade 21 is arranged at an upper surface side of the lower mold 10, the upper surface side being a surface facing the upper mold 4, in a protruding manner in a direction toward the upper mold 4. Further, an upper mold-side moving blade 32 of the moving blades 31, the upper mold-side moving blade 32 being the moving blade 31 provided to the upper mold 4, is provided at a lower surface side of the upper mold 4, the lower surface side being a surface facing the lower mold 10. A lower mold-side moving blade 33 of the moving blades 31, the lower mold-side moving blade 33 being the moving blade 31 provided to the lower mold 10, is provided to a surface of the lower mold 10 at a side to which the stationary blade 21 is arranged.

Hydraulic pressure generated by a hydraulic generator (not illustrated) can be supplied to the metal mold 1, and the upper mold 4 can be moved with the hydraulic pressure in a direction into which the distance between the upper mold 4 and the lower mold 10 is changed. Further, an application force transmission part 5 that can transmit force in a moving direction to the lower mold 10 is formed in the upper mold 4.

The application force transmission part 5 protrudes in a direction toward the lower mold 10, and an application force transmission surface 6 that is a inclined surface with respect to the moving direction of the upper mold 4 is formed in the vicinity of an end portion of the application force transmission part 5 at a side of the lower mold 10. To be specific, the application force transmission part 5 is provided to the upper mold 4 such that its position in a plan view of the metal mold 1 is different from a position of the stationary blade 21 arranged to the lower mold 10. The application force transmission surface 6 is formed facing a side where the stationary blade 21 is arranged, and facing downward. That is, the application force transmission surface 6 is inclined into a direction approaching the stationary blade 21 in a plan view of the metal mold 1, as going upward from a lower-side end portion of the application force transmission part 5.

Further, the metal mold 1 is provided with a pressing part 40 that is pressure means that provides the CFRP material 50 with pressure force in a moving direction of the moving blade 31 at the time of cutting the CFRP material 50. An upper mold pressing part 41 that is a part of the pressing part 40 is attached to the upper mold 4. The upper mold pressing part 41 is attached to a lower surface side of the upper mold 4, the lower surface side being a surface facing the lower mold 10, through an upper mold spring 8 that is elastic means made of a compression spring. Therefore, the position of the upper mold pressing part 41 in an up and down direction with respect to the upper mold 4 can be displaced, and energizing force in a direction toward the lower mold 10 is provided to the upper mold pressing part 41 from the upper mold spring 8.

Further, in a state where the upper mold spring 8 is not contracted by external surface, a lower-side surface, that is, a surface to be in contact with the CFRP material 50, of the upper mold pressing part 41, is positioned at a lower side than a moving-side blade part 35 formed at a tip of the upper mold-side moving blade 32.

Further a lower mold application part 11 movable with the force transmitted from the application force transmission part 5 at the time of moving the upper mold 4 is provided in the lower mold 10. The lower mold application part 11 is movably arranged in a direction into which the distance between the lower mold application part 11 and the stationary blade 21 is changed in a plan view of the metal mold 1, that is, in a horizontal direction where the moving direction of the upper mold 4 is an up and down direction. The lower mold-side moving blade 33 is provided at a surface of the lower mold application part 11, the surface facing the stationary blade 21.

Further, an application part pressing part 42 that is a part of the pressing part 40 is attached to the lower mold application part 11. This application part pressing part 42 is attached to a side surface of the lower mold application part 11, the side surface being a surface facing the stationary blade 21, through an application part spring 16 that is elastic means made of a compression spring. Therefore, the position of the application part pressing part 42 in a horizontal direction with respect to the lower mold application part 11, that is, the position into a direction of the distance between the application part pressing part 42 and the stationary blade 21 can be displaced, and energizing force in a direction toward the stationary blade 21 is provided from the application part spring 16.

Further, in a state where the application part spring 16 is not contracted with external force, a surface at the stationary blade 21 side, of the application part pressing part 42, is positioned at a more stationary blade 21 side than the moving-side blade part 35 formed at a tip of the lower mold-side moving blade 33. The application part pressing part 42 provided in this way is arranged at an upper side than a portion of the lower mold application part 11, where the lower mold-side moving blade 33 is arranged.

An application force receiving surface 12 that receives the force in the moving direction at the time of moving the upper mold 4 from the application force transmission part 5 of the upper mold 4 is formed on the lower mold application part 11. The application force receiving surface 12 is formed at a side of the lower mold application part 11, the side facing the upper mold 4, and faces a side opposite to the side where the stationary blade 21 is arranged. The application force receiving surface 12 is formed as a surface parallel to the application force transmission surface 6 of the upper mold 4. That is, the application force receiving surface 12 is inclined into a direction approaching the stationary blade 21 in a plan view of the metal mold 1, as going upward from a lower side of the lower mold application part 11. Further, the application force receiving surface 12 of the lower mold application part 11 is arranged to be positioned closer the stationary blade 21 than the

application force transmission surface 6 of the upper mold 4. In a state where the upper mold 4 is separated upward from the lower mold 10, the application force receiving surface 12 is separated from the application force transmission surface 6.

Further, a relief portion 22 that prevents the lower mold-side moving blade 33 from abutting on the stationary blade 21 when the lower mold application part 11 is moved into a direction approaching the stationary blade 21 is formed at a portion of the stationary blade 21, the portion facing the lower mold-side moving blade 33. The relief portion 22 is formed in a surface of the stationary blade 21, the surface facing the lower mold application part 11, and a portion at a lower side than the portion facing the lower mold-side moving blade 33 is formed to be recessed into a direction away from the lower mold application part 11 than a portion at an upper side than the portion facing the lower mold-side moving blade 33.

Further, a stationary-side blade part 25 that is a blade part used for cutting of the CFRP material 50 is formed at a lower end of a portion positioned above the relief portion 22 on the surface of the stationary blade 21, the surface facing the lower mold application part 11. Further, in the stationary blade 21, the stationary-side blade part 25 that is a blade part used for cutting the CFRP material 50 is similarly formed at an end portion on a surface of the stationary blade 21, the end portion being at a side of portion where the upper mold-side moving blade 32, and the surface facing the upper mold 4.

In contrast, the moving-side blade parts 35 that are blade parts used for cutting of the CFRP material 50 are formed at end portions of the upper mold-side moving blade 32 and the lower mold-side moving blade 33, the end portions being at the stationary blade 21 side. The upper mold-side moving blade 32 and the lower mold-side moving blade 33, and the stationary blade 21 respectively have the moving-side blade parts 35 and the stationary-side blade parts 25 used for cutting the CFRP material 50. These upper mold-side moving blade 32, lower mold-side moving blade 33, and stationary blade 21 configure the cutting mechanism 20 that can cut the CFRP material 50 by providing shear force to the CFRP material 50 in a thickness direction. That is, the cutting mechanism 20 can cut the CFRP material 50 using a pair of blades of the stationary blade 21 and the moving blades 31.

The pressing part 40 provided in the metal mold 1 can provide pressing force to the CFRP material 50 in a direction into which the shear force is provided to the CFRP material 50, when the CFRP material 50 is cut with the stationary blade 21 and the moving blades 31. That is, the upper mold pressing part 41 is moved with the movement of the upper mold 4, thereby providing the pressing force to the CFRP material 50 in a direction into which the upper mold-side moving blade 32 and the stationary blade 21 provide the shear force to the CFRP material 50. Similarly, the application part pressing part 42 is moved in accordance with the lower mold application part 11 that is linked with the upper mold 4, thereby providing the pressing force to the CFRP material 50 in a direction into which the lower mold-side moving blade 33 and the stationary blade 21 provide the shear force to the CFRP material 50.

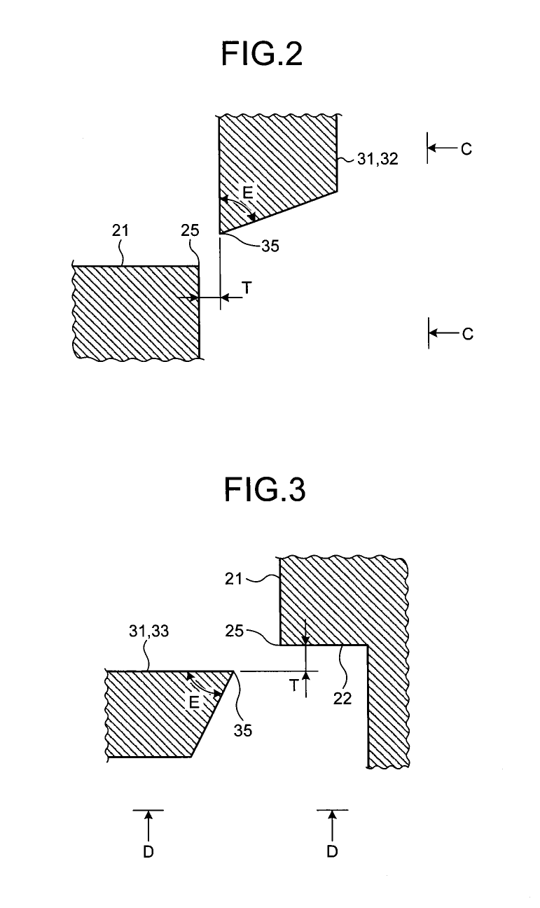

FIG. 2 is a detailed diagram of an A part of FIG. 1. FIG. 3 is a detailed diagram of a B part of FIG. 1. The positions in the directions perpendicular to the moving directions of the moving blades 31 movable with the movement of the upper mold 4 are different from those of the stationary-side blade parts 25 of the stationary blade 21. To be specific, the upper mold-side moving blade 32 is arranged such that the position in the direction perpendicular to the moving direction, that is, the position in the horizontal direction is more shifted to an opposite side to the side where the stationary blade 21 is positioned, than the stationary-side blade part 25. Therefore, the upper mold-side moving blade 32 is not in contact with the stationary-side blade part 25 even if the upper mold-side moving blade 32 is moved to a portion where the stationary-side blade part 25 is positioned, in the moving direction of the upper mold-side moving blade 32, and is positioned at a side portion of the stationary-side blade part 25, being separated from the stationary-side blade part 25.

Further, the lower mold-side moving blade 33 is arranged such that the position in a direction perpendicular to the moving direction, that is, the position in the up and down direction is shifted to a side where the relief portion 22 is positioned than the stationary-side blade part 25 formed at an upper end of the relief portion 22 of the stationary blade 21. Therefore, the lower mold-side moving blade 33 is not in contact with the stationary-side blade part 25 even if the lower mold-side moving blade 33 is moved to a portion where the stationary-side blade part 25 is positioned, in the moving direction of the lower mold-side moving blade 33, and is positioned below the stationary-side blade part 25, being separated from the stationary-side blade part 25.

To be specific, the moving blades 31 of the upper mold-side moving blade 32 and the lower mold-side moving blade 33 have clearances T between the moving blades 31 and the stationary blade 21, which is the distance from the moving blades 31 to the stationary blade 21 in the directions perpendicular to the moving directions of when the moving blades 31 come at the same position as the stationary blade 21, in the respective moving directions, to fall within a range from 0.025 to 0.075 mm, both exclusive. That is, the respective moving-side blade parts 35 of the upper mold-side moving blade 32 and the lower mold-side moving blade 33 and the stationary-side blade parts 25 formed at positions facing the respective moving-side blade parts 35 have the clearances T in the directions perpendicular to the respective moving directions of the moving blades 31 to fall within a range from 0.025 to 0.075 mm, both exclusive.

Further, a blade edge angle of the moving-side blade parts 35 of the moving blades 31 are formed into an acute angle. That is, the upper mold-side moving blade 32 and the lower mold-side moving blade 33 have the moving-side blade parts 35 formed at tips in the moving directions, and positions close to the stationary-side blade parts 25, in the directions perpendicular to the moving directions of the moving blades 31, and cross section shapes of the moving-side blade parts 35 are formed to have an acute angle. Note that a blade edge angle E of the moving blades 31, which is formed into an acute angle in this way, falls within a range from 60° to 90°, both inclusive, and is most favorably 60°.

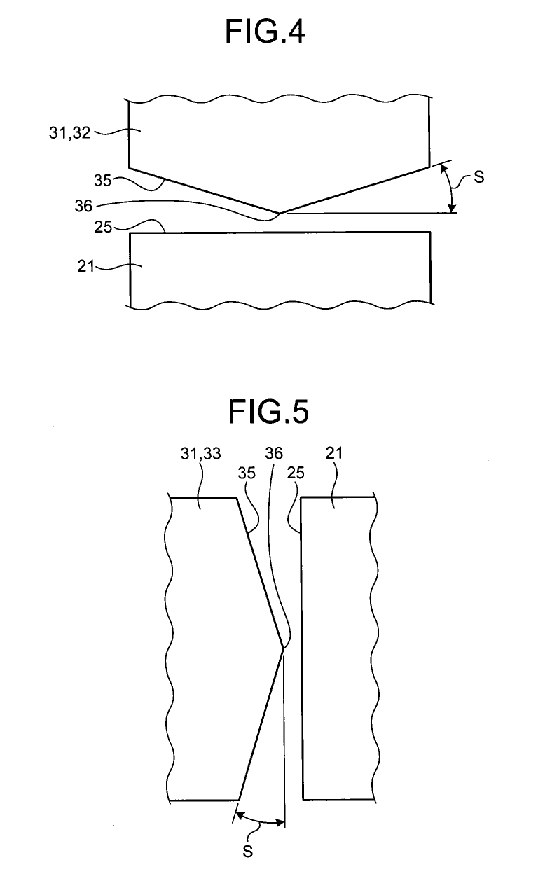

FIG. 4 is a C-C arrow view of FIG. 2. FIG. 5 is a D-D arrow view of FIG. 3. The blade edges of the moving blades 31 are inclined toward the moving directions of the moving blades 31. To be specific, a tip end portion of the upper mold-side moving blade 32 is formed into a protruding shape in a direction toward the stationary blade 21, and the upper mold-side moving blade 32 is inclined in directions away from the stationary blade 21, as being separated from a position closest to the stationary blade 21 in the horizontal directions along the stationary-side blade part 25 facing the upper mold-side moving blade 32. Similarly, a tip end portion of the lower mold-side moving blade 33 is formed into a protruding shape in a direction toward the stationary blade 21, and the lower mold-side moving blade 33 is inclined in directions away from the stationary blade 21, as being separated from a position closest to the stationary blade 21 in the horizontal directions along the stationary-side blade part 25 facing the lower mold-side moving blade 33.

That is, the moving-side blade parts 35 of the moving blade 31 have mountain portions 36 at positions closest to the stationary blade 21 in the moving directions of the moving blades 31, and are inclined from the mountain portions 36 in directions away from the stationary blade 21, as being separated in the horizontal directions along the stationary-side blade part 25. Shearing angles S that are inclined angles of the moving-side blade parts 35 inclined in directions away from the stationary blade 21, as being separated from the mountain portions 36, are from 0° to 10° both exclusive.

Further, the inventors have performed tests about conditions with which the CFRP material can be appropriately cut, when the stationary blade 21 and the moving blades 31 provide the shear force to the CFRP material to cut the CFRP material. Next, a result of the test will be described. The test was performed by observing of cut states of the blade edge shapes of the moving blades 31, a cut state of the clearances of the stationary blade 21 and the moving blades 31, and a cut state of the pressing force provided to the CFRP material at the time of cutting the CFRP material.

First, the test of the cut states of the blade edge shapes of the moving blades 31 will be described. The test was performed about displacement of the moving blades and change of the shear stress of when a CFRP sample is cut with a plurality of moving blades having different shearing angles S as moving blades of a test machine, and the stationary blade. Further, the test was performed using the moving blade having the shearing angles S of 0°, 5°, and 30°.

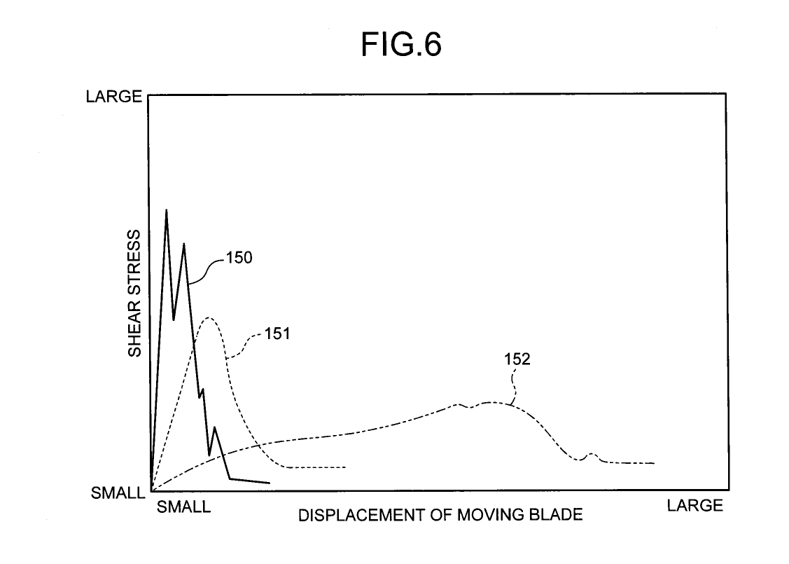

FIG. 6 is an explanatory diagram about results of the tests about blade edge states of the moving blades. As a result of the tests with the moving blades having the respective shearing angles S, in the test with the moving blade having the shearing angle S of 0°, the shear stress was sharply increased with respect to the displacement of the moving blade after the moving blade comes in contact with the CFRP sample, and was then sharply decreased, as illustrated by the cut state 150 at 0°. In the test with the moving blade having the shearing angle S of 5°, similarly, the shear stress was sharply increased with respect to the displacement of the moving blade after the moving blade comes in contact with the CFRP sample, and was then sharply decreased, as illustrated by the cut state 151 at 5°. That is, it has been found out that, when the shearing angles S of the moving blades are 0° or 5°, the CFRP samples are cut at a relatively early period of time after the moving blades come in contact with the CFRP samples.

In contrast, in the test with the moving blade with the shearing angle S of 30°, the shear stress was less likely to be increased with respect to the displacement of the moving blade after the moving blade comes in contact with the CFRP sample, compared with the moving blades of 0° and 5°, and the shear stress was continuously generated even after the displacement amount of the moving blade becomes relatively large, as illustrated by the cut state 152 at 30°. That is, it has been found out that, when the shearing angle S of the moving blade is 30°, larger displacement of the moving blade is required than the cases of the shearing angles S of 0° or 5° after the moving blade comes in contact with the CFRP sample.

Next, a test about a cut state of a clearance between the stationary blade 21 and the moving blade 31 will be described. As the CFRP sample used in the test about the cut state of the clearance between the stationary blade 21 and the moving blade 31, a square plate having 40 mm (length)×10 mm (width)×1.2 mm (0.15 mm×8 layers) (thickness) is used. The test is performed such that the clearance between the moving blade and the stationary blade of the test machine was changed and the CFRP sample was cut, the cross section surface of the sample was observed.

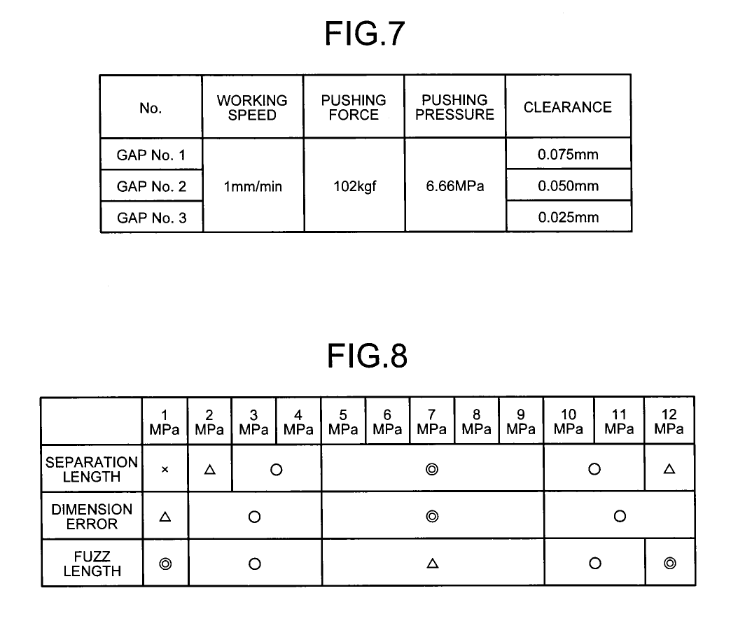

FIG. 7 is an explanatory diagram about conditions of the test about the cut state of the clearance. As the conditions of the test, the working speed at the time of cutting was 1 mm/min, the pushing force of the CFRP sample was 102 kgf, and the pushing pressure was 6.66 MPa. Further, the tests were performed as gaps Nos. 1 to 3 by changing the clearance between the moving blade and the stationary into three stages. The clearances of the respective tests were 0.075 mm in gap No. 1, 0.050 mm in gap No. 2, and 0.025 mm in gap No. 3.

With the conditions, the CFRP sample was cut, and the cross section surface of each observation position after cutting was observed with a microscope. As a result, in gap No. 1, there was no particular interlayer separation, and there was less fuss. However, it has been confirmed that a dimension error at the time of cutting is large. Further, in gap No. 3, it has been confirmed that, while the dimension error is small at the time of cutting, the interlayer separation is partially generated, and there is much fuzz. In gap No. 2, it has been confirmed that there is no particular interlayer separation and less fuzz, and the dimension error at the time of cutting is small. Therefore, it has been found out that, from these tests, the clearance between the moving blade and the stationary blade is about 0.05 mm, so that the cutting can be performed with a favorable cross section surface, and the dimension error can be made small.

Next, a test of a cut state of pressing force provided to the CFRP material at the time of cutting will be described. As the CFRP sample that is a sample used for the test of a cut state of pressing force provided to the CFRP material, a square plate having 40 mm (length)×10 mm (width)×1.1 mm (0.15 mm×8 layers) (thickness) is used. The test is performed such that the pressing force provided to the CFRP sample when cutting the CFRP sample by the test device is changed and the CFRP sample is cut, and the cross section surface of the CFRP sample is observed.

FIG. 8 is an explanatory diagram about an evaluation result of a cut state test with respect to pressing force. Results of changing the pressing force and cutting the CFRP sample, and observing the cross section surface of observation positions after cutting with a microscope will be described. In this cut test with respect to the pressing force, the length of the interlayer separation of the cross section surface, the dimension error, and the length of fuzz were observed, and evaluated on a scale of one to four based on the degree. In FIG. 8, the evaluation results were illustrated with the marks of x, Δ, ∘, and ⊚ from poor evaluation to good evaluation.

According to the evaluation results illustrated in FIG. 8, an allowable value of the interlayer separation length is 2 to 12 MPa, and a recommended value is 5 to 9 MPa. Further, an allowable value of the dimension error is 3 to 12 MPa, and a recommended value is 5 to 9 MPa. Further, an allowable value of the fuzz length is 1 to 12 MPa, and a recommended value is less than 2 MPa or 11 MPa or more. To summarize these evaluation results, it has been found out that an allowable value of the pushing pressure of the CFRP material is 3 to 10 MPa, and a recommended value is 5 to 9 MPa.

The metal mold 1 according to the first embodiment is made of the above configuration. Hereinafter, its effects, and a method of manufacturing the CFRP component according to the first embodiment will be described. FIG. 9 is an explanatory diagram illustrating a state of when the CFRP material is cut with the metal mold illustrated in FIG. 1. In the metal mold 1 according to the first embodiment, with regard to the CFRP material 50, a removed portion 56 that is an unwanted part around a portion to be molded 51 used in a subsequent process is removed by being cut from the portion to be molded 51. When cutting of the removed portion 56 is performed, the CFRP material 50 after being molded with another metal mold for molding the CFRP material 50 is placed between the upper mold 4 and the lower mold 10 in a state where the upper mold 4 is separated from the lower mold 10. To be specific, the CFRP material 50 after molded is covered on the stationary blade 21 formed in a protruding manner on the lower mold 10.

FIG. 10 is an explanatory diagram illustrating a state at the time of start of cutting the CFRP material illustrated in FIG. 9. When the removed portion 56 of the CFRP material 50 is cut, the upper mold 4 is moved downward with the hydraulic pressure generated by the hydraulic pressure generator in a state where the CFRP material 50 is placed on the stationary blade 21. Accordingly, both of the upper mold-side moving blade 32 and the upper mold pressing part 41 approach the CFRP material 50.

Further, when the upper mold 4 has been moved downward, the application force transmission surface 6 of the application force transmission part 5 comes in contact with the application force receiving surface 12 of the lower mold application part 11. The application force receiving surface 12 is arranged closer to the stationary blade 21 than the application force transmission surface 6, and the application force transmission surface 6 and the application force receiving surface 12 are inclined in a direction approaching the direction where the stationary blade 21 is arranged, as both going upward from a lower side.

Therefore, when the application force transmission surface 6 comes in contact with the application force receiving surface 12 with the upper mold 4 being moved downward, the force of the upper mold 4 transmitted to the lower mold application part 11 through the application force transmission part 5 is transmitted to the lower mold application part 11 as force that moves the lower mold application part 11 into the stationary blade 21 side. Accordingly, the lower mold application part 11 is moved in a direction approaching the stationary blade 21 together with the lower mold-side moving blade 33 and the application part pressing part 42.

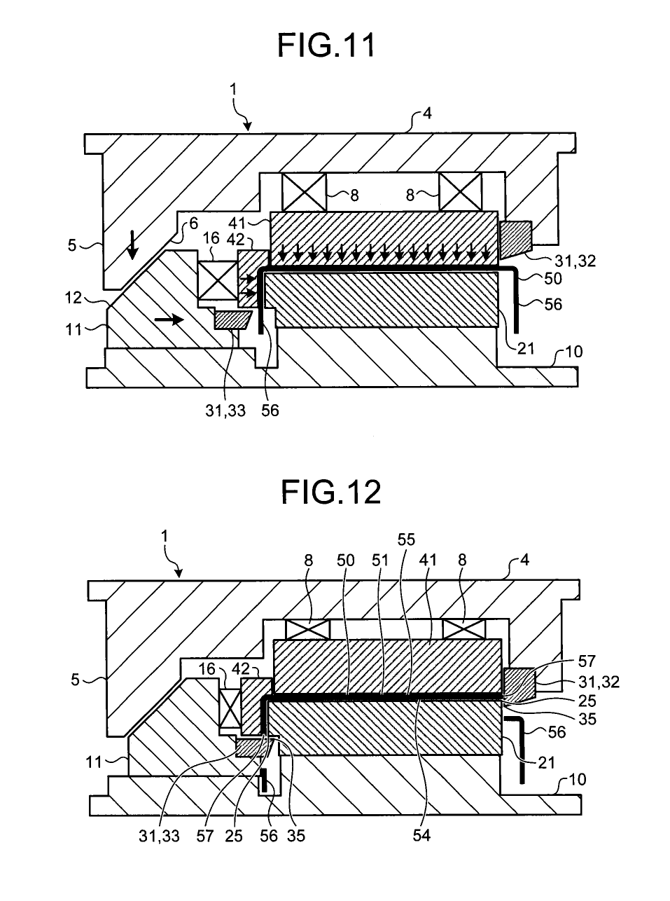

FIG. 11 is an explanatory diagram illustrating a state in which the pressing force is provided to the CFRP material illustrated in FIG. 10 with the pressing part. When the upper mold 4 is moved downward, the lower surface of the upper mold pressing part 41, which is a surface facing the CFRP material 50, comes in contact with the CFRP material 50. In this state, when the upper mold 4 is further moved downward, compression force acts on the upper mold spring 8, and the upper mold spring 8 is contracted with the force. Meanwhile, the upper mold pressing part 41 is pushed to the CFRP material 50 with the energizing force from the contracted upper mold spring 8, and becomes in a state of providing the pressing force to the CFRP material 50.

Further, when the upper mold 4 is moved downward in a state where the application force transmission surface 6 is in contact with the application force receiving surface 12 of the lower mold application part 11, the lower mold application part 11 is moved in a direction approaching the stationary blade 21 with the force transmitted from the application force transmission surface 6 to the application force receiving surface 12. Accordingly, the surface of the application part pressing part 42, the surface facing the CFRP material 50, comes in contact with the CFRP material 50. In the state, when the upper mold 4 is further moved downward, and the lower mold application part 11 is further moved, the compression force acts on the application part spring 16, and the application part spring 16 is contracted with the force. Meanwhile, the application part pressing part 42 is pushed to the CFRP material 50 with the energizing force from the contracted application part spring 16, and becomes in a state of providing the pressing force to the CFRP material 50.

When the upper mold 4 is moved toward the lower mold 10 side in order to cut the CFRP material 50, the pressing force is provided from the upper mold pressing part 41 and the application part pressing part 42 to the CFRP material 50. The pressing force of in this case is within the range from 3 to 10 MPa, both inclusive, and is favorably a range from 5 to 9 MPa, both inclusive.

FIG. 12 is an explanatory diagram illustrating a state in which the CFRP material illustrated in FIG. 11 is cut. The upper mold 4 is further moved in the direction of the lower mold 10 in a state where the pressing force is provided to the CFRP material 50 by the pressing part 40, so that the upper mold-side moving blade 32 is moved in the direction of the stationary blade 21. That is, the upper mold-side moving blade 32 is arranged at a moving blade surface 55 side in the CFRP material 50, the moving blade surface 55 being a surface at an opposite to a stationary blade surface 54, which is a surface of a side where the stationary blade 21 is positioned, and the upper mold 4 is moved toward the lower mold 10 at the time of cutting the CFRP material 50. Accordingly, the upper mold-side moving blade 32 is moved from the moving blade surface 55 side of the CFRP material 50 to the stationary blade surface 54 side.

The positions of the upper mold-side moving blade 32 and the stationary blade 21 arranged at both ends of the CFRP material 50 in the thickness direction are shifted in a direction perpendicular to the moving direction of the upper mold-side moving blade 32, and the clearance between the moving-side blade part 35 of the upper mold-side moving blade 32 and the stationary-side blade part 25 facing the upper mold-side moving blade 32 is within a range from 0.025 to 0.075 mm, both exclusive. Therefore, the upper mold-side moving blade 32 is moved toward the CFRP material 50, and the CFRP material 50 is sandwiched by the upper mold-side moving blade 32 and the stationary blade 21 from both sides, so that the upper mold-side moving blade 32 and the stationary blade 21 can provide the shear force to the CFRP material 50.

A cut portion 57 of the CFRP material 50 is sandwiched by the upper mold-side moving blade 32 and the stationary blade 21 from both side, and the shear force is provided to the cut portion 57, whereby the cutting mechanism 20 cut the CFRP material 50 with the cut portion 57. The cutting mechanism 20 removes the removed portion 56 from the portion to be molded 51 by cutting the CFRP material 50 at the cut portion 57 in this way.

Further, the lower mold-side moving blade 33 is arranged at the moving blade surface 55 side in the CFRP material 50, the moving blade surface 55 being a surface at an opposite side to the stationary blade surface 54, which is a surface of a side where the stationary blade 21 is positioned, and the lower mold application part 11 is moved in the direction of the stationary blade 21 with the movement of the upper mold 4. Therefore, the lower mold-side moving blade 33 is moved from the moving blade surface 55 side of the CFRP material 50 to the stationary blade surface 54 side.

Further, the positions of the moving-side blade part 35 of the lower mold-side moving blade 33 and the stationary-side blade part 25 facing the lower mold-side moving blade 33 are shifted in the direction perpendicular to the moving direction of the lower mold-side moving blade 33, and the clearance between them falls within the range from 0.025 to 0.075 mm, both exclusive. Therefore, the lower mold-side moving blade 33 is moved toward the CFRP material 50, and the CFRP material 50 is sandwiched by the lower mold-side moving blade 33 and the stationary blade 21 from both sides, so that the lower mold-side moving blade 33 and the stationary blade 21 can provide the shear force to the CFRP material 50. The cutting mechanism 20 cuts the CFRP material 50 at the cut portion 57 of the CFRP material 50 with the shear force. The cutting mechanism 20 cuts the removed portion 56 from the portion to be molded 51 by cutting the CFRP material 50 at the cut portion 57.

At that time, the shearing angles S of the moving-side blade parts 35 of the upper mold-side moving blade 32 and the lower mold-side moving blade 33 are both less than 10°. Therefore, the inclined angle of the moving blades 31 in the moving direction with respect to the moving blade surface 55 of the CFRP material 50 becomes less than 10°. Accordingly, deformation of the CFRP material 50 at the time of cutting can be made small and the cutting can be performed.

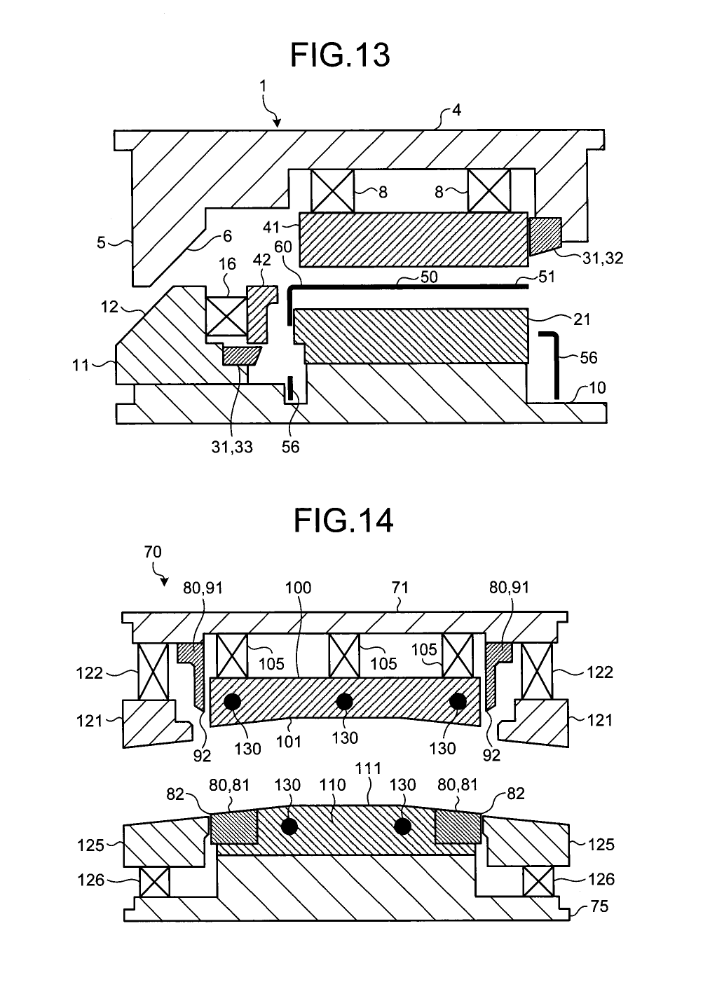

FIG. 13 is an explanatory diagram of when the CFRP component after cutting is taken out. When the removed portion 56 of the CFRP material 50 is cut by the upper mold 4 and the lower mold 10, the upper mold 4 is moved upward, so that the upper mold 4 is separated from the lower mold 10. Thus, the portion to be molded 51 of the CFRP material 50 is taken out. This portion to be molded 51 is used as a CFRP component 60 used in the post process at the time of manufacturing a member using CFRP because the removed portion 56 that is an unwanted part has been cut and removed from the portion to be molded 51.

The metal mold 1 according to the first embodiment cuts the CFRP material 50 by providing the shear force to the CFRP material 50 by the stationary blade 21 and the moving blade 31. Therefore, the metal mold 1 can cut the CFRP material 50 in a short time. As a result, the cutting of the CFRP material 50 can be easily performed.

Further, the shearing angles S of the moving-side blade parts 35 of the moving blades 31 is less than 10°. Therefore, the metal mold 1 can make the deformation small and cut the CFRP material 50. As a result, the fuzz or interlayer separation caused by the deformation of the CFRP material 50 can be suppressed, and the cutting of the CFRP material 50 can be further easily performed.

The clearance T between the moving blade 31 and the stationary blade 21 falls within the range from 0.025 to 0.075 mm, both exclusive. Therefore, the fuzz or interlayer separation of the cut surface of the CFRP material 50 can be decreased, and the cutting can be performed in a state where the dimension error is small. As a result, the CFRP material 50 can be cut with a favorable cut surface state.

Further, the blade edge angles E of the moving blades 31 fall within the range from 60° to 90°, both inclusive. Therefore, the CFRP material 50 can be cut without being squashed and deformed. As a result, the fuss or interlayer separation of the cut surface can be more reliably suppressed, and the CFRP material 50 can be cut.

Further, at the time of cutting the CFRP material 50, the pressing part 40 provides the pressing force to the CFRP material 50 within the range from 3 to 10 MPa, both inclusive. Therefore, the interlayer separation, the fuzz of the cut surface, and the dimension error do not become excessively large, and can fall within the allowable ranges. As a result, the CFRP material 50 can be cut with a more favorable cut surface state. Further, when the pressing force provided to the CFRP material 50 falls within the range from 5 to 9 MPa, both inclusive, the interlayer separation, the fuzz of the cut surface, and the dimension error can fall within a more appropriate range, and the CFRP material 50 can be cut with a more favorable cut surface state.

Further, the method of manufacturing the CFRP component 60 according to the first embodiment cuts the CFRP material 50 by providing the shear force to the CFRP material 50 in the thickness direction. Therefore, the CFRP material 50 can be cut in a short time. As a result, the CFRP material 50 can be easily cut.

Further, in the method of manufacturing the CFRP component 60 according to the first embodiment, the cutting of the CFRP material 50 is performed using the moving blades 31 having the shearing angles S of less than 10°. Therefore, the deformation of the CFRP material 50 at the time of cutting can be made small. As a result, the fuzz or interlayer separation caused by the deformation of the CFRP material 50 can be decreased, and the cutting of the CFRP material 50 can be more reliably and easily performed.

Further, in the method of manufacturing the CFRP component 60 according to the first embodiment, the CFRP material 50 is cut from both sides in the thickness direction of the CFRP material 50 using the stationary blade 21 and the moving blade 31 in which the clearance T in the direction perpendicular to the direction of the shear force falls within the range from 0.025 to 0.075 mm, both exclusive. Therefore, the interlayer separation or fuzz of the cut surface are decreased, and the dimension error at the time of cutting can be made small. As a result, the CFRP material 50 can be cut with a favorable cut surface state.

Further, in the method of manufacturing the CFRP component 60 according to the first embodiment, the pressing force is provided to the CFRP material 50 in the direction providing the shear force within the range from 3 to 10 MPa, both inclusive, at the time of cutting the CFRP material 50. Therefore, the interlayer separation, the fuzz of the cut surface, and the dimension error can fall within the allowable ranges. As a result, the CFRP material 50 can but with a favorable cut surface state.

### Second Embodiment

A metal mold 70 according to a second embodiment has approximately the same configuration as the metal mold 1 according to the first embodiment. However, the metal mold 70 has a characteristic in molding a CFRP material 50. Since other configurations are similar to the first embodiment, description thereof is omitted, and the same reference signs are denoted.

FIG. 14 is a schematic diagram of a metal mold for carbon fiber reinforced plastic component according to the second embodiment. The metal mold 70 according to the second embodiment is, similarly to the metal mold 1 according to the first embodiment, a principal part of a device used for manufacturing components made of CFRP, and includes an upper mold 71 relatively arranged at an upper side, and a lower mold 75 arranged below the upper mold 71.

Further, the metal mold 70 includes a cutting mechanism 80 including a stationary blade 81 and a moving blade 91. The metal mold 70 can cut a CFRP material 50 with the cutting mechanism 80. Among the stationary blade 81 and the moving blade 91 that configure the cutting mechanism 80, the stationary blade 81 is provided in the lower mold 75, and the moving blade 91 is provided in the upper mold 71. The upper mold 71 approaches the lower mold 75, so that the moving blade 91 and the stationary blade 81 can cut the CFRP material 50.

Further, similarly to the moving blade 31 of the metal mold 1 according to the first embodiment, a blade edge angle of the moving blade 91 is in a range from 60° to 90°, both inclusive, most favorably 60°, and a shearing angle S is from 0° to 10°, both exclusive. Further, a clearance between the moving blade 91 and the stationary blade 81 in a direction perpendicular to a moving direction of the moving blade 91 falls within a range from 0.025 to 0.075 mm, both exclusive, similarly to the moving blade 31 and the stationary blade 21 of the metal mold 1 according to the first embodiment.

Further, a pressing part 100 that is pressing means that provides pressing force to the CFRP material 50 in a moving direction of the moving blade 91 at the time of cutting a CFRP material 50 is provided in the upper mold 71. The pressing part 100 is attached to a lower surface of the upper mold 71, the lower surface being a surface facing the lower mold 75, through a pressing part spring 105 that is elastic means made of a compression spring. Therefore, the position of the pressing part 100 in an up and down direction with respect to the upper mold 71 can be displaced, and energizing force in a direction toward the lower mold 75 is provided to the pressing part 100 from the pressing part spring 105.

Further, a surface of the pressing part 100, the surface facing the lower mold 75, is formed as an upper mold molding surface 101 that comes in contact with the CFRP material 50 at the time of molding the CFRP material 50, and molds the CFRP material 50.

Meanwhile, a lower mold molding part 110 including a lower mold molding surface 111 that molds the CFRP material 50 by sandwiching the CFRP material 50 between the lower mold molding surface 111 and the upper mold molding surface 101 is provided in the lower mold 75. This lower mold molding part 110 is arranged in a surface of the lower mold 75, the surface facing the upper mold 71, in a protruding manner in a direction toward an upper mold 71 side, and the lower mold molding surface 111 is a surface facing the upper mold 71, in the lower mold molding part 110. These upper mold molding surface 101 and lower mold molding surface 111 have shapes to be able to mold the CFRP material 50 in a desired shape by sandwiching the CFRP material 50. That is, the upper mold molding surface 101 and the lower mold molding surface 111 serve as a molding part that molds the CFRP material 50 in the metal mold 70.

The stationary blade 81 is arranged in a periphery of the lower mold molding part 110 in a horizontal direction, and a stationary-side blade part 82 is formed on a surface of an upper mold 71 side, in the stationary blade 81, and at an outer periphery side in the horizontal direction. The shape of an upper surface of the stationary blade 81 is formed continuous from the lower mold molding surface 111 of the lower mold molding part 110.

Further, the moving blade 91 is provided downward at a lower surface of the upper mold 71, the surface facing the lower mold 75, and near a position facing the stationary-side blade part 82. A moving-side blade part 92 that cuts the CFRP material 50 with the stationary-side blade part 82 is formed at an end portion of the moving blade 91 close to the lower mold 75.

In a state where the pressing part spring 105 is not contracted with external force, a lower-side surface, that is, a surface to be in contact with the CFRP material 50, of the pressing part 100, is positioned at a lower side than the moving-side blade part 92 formed at a tip of the moving blade 91.

Further, the metal mold 70 according to the second embodiment includes an upper mold row material holding part 121 and a lower mold row material holding part 125 that hold the CFRP material 50 at the time of molding the CFRP material 50. Among them, the upper mold row material holding part 121 is arranged at a lower surface side of the upper mold 71, the lower surface side facing the lower mold 75, at an outside of the moving blade 91 in the horizontal direction, that is, at an opposite side to a side where the pressing part 100 is positioned, as viewed from the moving blade 91. Further, the upper mold row material holding part 121 is attached to the lower surface side of the upper mold 71 through an upper mold holding part spring 122 that is elastic means made of a compression spring, similarly to the pressing part 100. Therefore, the position of the upper mold row material holding part 121 in an up and down direction can be displaced with respect to the upper mold 71, and energizing force is provided to the upper mold row material holding part 121 from the upper mold holding part spring 122 in a direction toward the lower mold 75.

Further, a lower-side surface of the upper mold row material holding part 121, the lower-side surface being a surface to be in contact with the CFRP material 50 is arranged to be positioned closer to the lower mold 75 than the upper mold molding surface 101 of the pressing part 100.

Further, the lower mold row material holding part 125 is arranged at an upper surface side of the lower mold 75, the upper surface side being a surface facing the upper mold 71, and near a position facing the upper mold row material holding part 121. Further, the lower mold row material holding part 125 is attached to the upper surface side of the lower mold 75 through a lower mold holding part damper 126 that is contractable in the up and down direction with hydraulic pressure or electromagnetic force. Therefore, the lower mold row material holding part 125 is arranged such that the position in the up and down direction can be displaced with respect to the lower mold 75. Note that the lower mold holding part damper 126 may be any other parts than the one that moves the lower mold row material holding part 125 in a positive manner. The lower mold holding part damper 126 may be one that supports the lower mold row material holding part 125 in a state of upwardly providing energizing force with a gas spring, and the lower mold holding part damper 126 is contracted by an input of external force into a lower-side direction with respect to the lower mold row material holding part 125, thereby to hold the lower mold row material holding part 125 displaceable in the up and down direction, for example.

Further, the metal mold 70 according to the second embodiment can easily cut the CFRP material 50 made of a thermosetting resin. Therefore, heaters 130 that are heating means to heat the CFRP material 50 are provided inside the pressing part 100 and the lower mold molding part 110, respectively. The heater 130 is configured such that high-temperature machine oil can circulate inside the heater, and can heat a cut portion of the CFRP material 50, which is cut by the cutting mechanism 80, by transmitting heat of the machine oil.

Further, the inventors have performed tests about a cut state with respect to the temperature of the CFRP material, as tests about conditions with which the CFRP material can be appropriately cut when the CFRP material is cut by being provided shear force by the stationary blade 81 and the moving blade 91. Next, the tests of the cut state with respect to the temperature will be described.

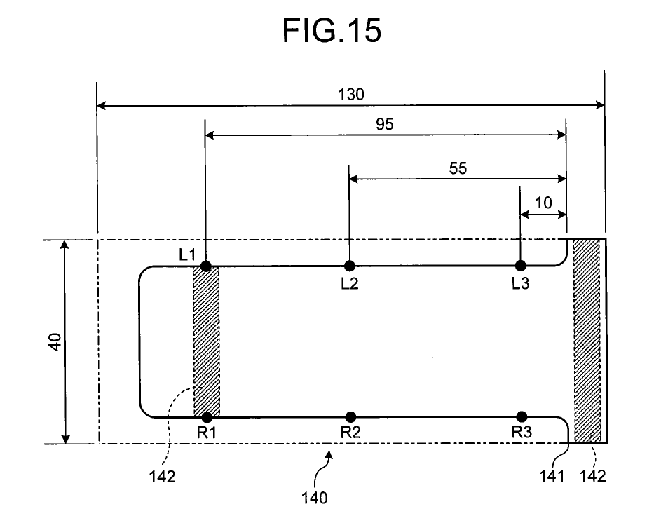

FIG. 15 is a simplified diagram of a sample when a test of a cut state with respect to temperature is performed. As a CFRP sample 140 that is a sample used in the test about the cut state with respect to the temperature of the CFRP material, a square plate having 130 mm (length)×40 mm (width)×0.70 mm (0.14 mm×5 layers) (thickness) is used. The test is performed such that the CFRP sample 140 is cut into an approximately U shape with the shear force by the moving blade (not illustrated) and the stationary blade (not illustrated) of a test device (not illustrated) in a direction in which the length direction of the CFRP sample 140 is the depth direction of the U shape, and the cut surface is observed.

Regarding positions of observation, the position corresponding to an end portion of a U-shaped opening portion is a reference position 141, and two places in the width direction of the U-shaped opening at a plurality of positions in the length direction from the reference position 141 are respectively observed. To be specific, two positions in the width direction of the U-shaped opening at the position where the distance from the reference position 141 is 95 mm are L1 and R1. Similarly, two positions at the position where the distance from the reference position 141 is 55 mm are L2 and R2, and two positions at the position where the distance from the reference position 141 is 10 mm are L3 and R3.

As a heat source that heats the CFRP sample 140 to judge the cut state with respect to the temperature, an electric heater (not illustrated) is used. In the test device, heat source positions 142 that are positions where the electric heater is arranged are a portion where the L1 and R1 are positioned in the length direction of the CFRP sample 140, and a position at an opposite side to the side where the observation positions are positioned in the length direction with respect to the reference position 141, and in the vicinity of the reference position 141.

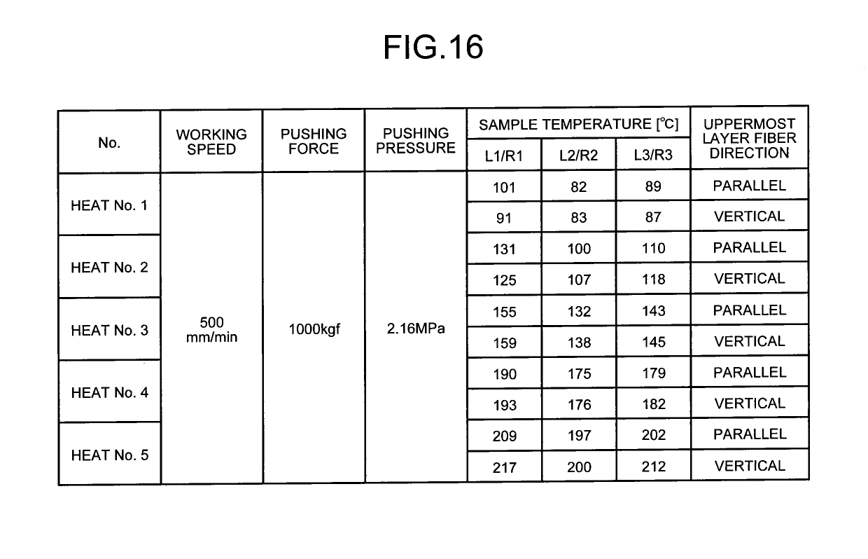

FIG. 16 is an explanatory diagram about conditions of a cut state test with respect to the temperature. As the conditions of the test, the working speed at the time of cutting was 500 mm/min, the pushing force of pushing the CFRP sample 140 for cutting it was 1000 kgf, and the pushing pressure was 2.16 MPa. Further, the tests were performed as heats Nos. 1 to 5 by changing an output of the heat source in heating the CFRP sample 140 into five stages. Further, in each output of the heat source, tests in which the direction of carbon fiber of the CFRP sample 140 is changed was performed. A test with a sample where the direction of uppermost fiber of laminated fiber is parallel to the length direction of the CFRP sample 140, and a test with a sample where the direction of uppermost fiver is vertical to the length direction are respectively performed. The temperature at each observation position when these tests are performed is illustrated in FIG. 16.

With these conditions, the CFRP sample 140 was cut, and the cut surface of each observation position after cutting was observed with a microscope. As a result, in heat No. 1, it has been confirmed that the carbon fiber of the cut surface becomes irritable, and a lot of so-called fuzz is generated. Further, in heats Nos. 3 to 5, it has been confirmed that the interlayer separation of the laminated carbon fiber is generated. In contrast, in heat No. 2, a favorable state of the cut surface has been confirmed.

Actual temperature at each observation position of the CFRP sample 140 of when these tests were performed was 82° C. to 101° C. in heat No. 1, 100° C. to 131° C. in heat No. 2, 132° C. to 217° C. in heats Nos. 3 to 5. As a result of examination of these temperatures, it has been found out that the temperature at the observation positions in heat No. 2 is the temperature in the vicinity of the glass transition point of the CFRP material, to be specific, the temperature in the vicinity of the glass transition point of a synthetic resin that configures the CFRP material. With these tests, it has been found out that, when the CFRP material is cut in a state where the temperature of the CFRP material is raised to the temperature in the vicinity of the glass transition point, the CFRP material can be cut with a favorable cut surface state without generating the fuzz or interlayer separation in the cut surface at the time of cutting.

The inventors who recognized that they can perform favorable cutting by raising the CFRP material to the temperature in the vicinity of the glass transition point have performed tests about the quality of the cut state with respect to temperature change in cutting the CFRP material at the temperature in the vicinity of the glass transition point. Next, quality tests of the cut state with respect to temperature change in the vicinity of the glass transition point will be described.

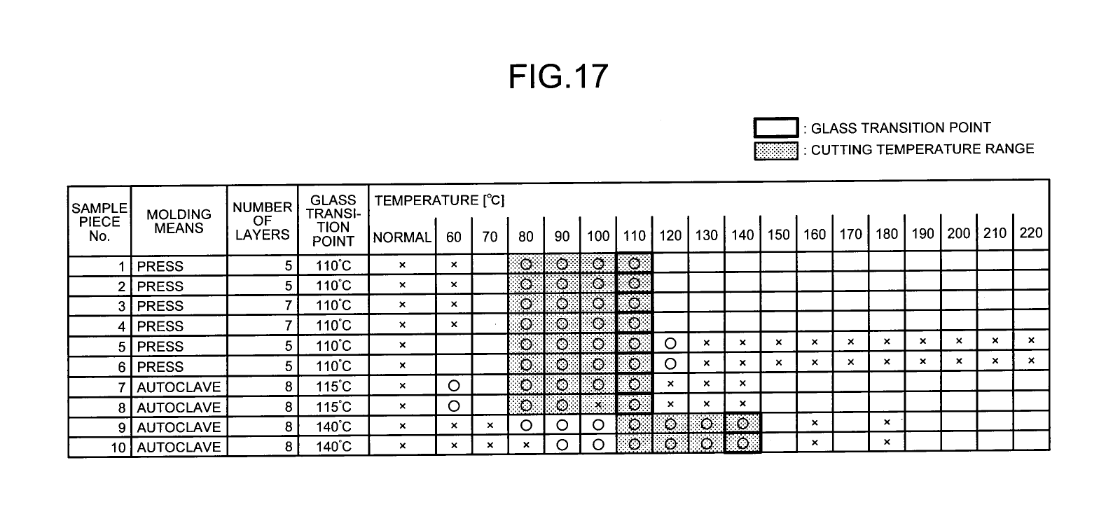

FIG. 17 is an explanatory diagram about quality tests of a cut state with respect to temperature change in the vicinity of a glass transition point. The tests about the temperature change in the vicinity of the glass transition point were performed such that ten types of tests where configurations of the CFRP material or the glass transition points are different were performed as test pieces Nos. 1 to 10. Among these tests, in test pieces Nos. 1 to 6, the CFRP materials are molded with a press, and in test pieces Nos. 7 to 10, the CFRP materials are molded with an autoclave.

Further, these CFRP materials have different number of layers. The number of layers in test pieces Nos. 1, 2, 5, and 6 are five, the number of layers in test pieces Nos. 3 and 4 are seven, and the number of layers in test pieces Nos. 7 to 10 are eight. Further, these CFRP materials have different glass transition points. The glass transition point of test pieces Nos. 1 to 6 is 110° C., the glass transition point of test pieces Nos. 7 and 8 is 115° C., and the glass transition point of test pieces Nos. 9 and 10 is 140° C.

Note that the temperature of the glass transition point is changed depending on a curing state of a resin that configures the CFRP material. For example, in test pieces Nos. 1 to 8, the same material is used but the molding mean is different. Therefore, the temperatures of the glass transition point are different. Typically, the glass transition point becomes higher as the crosslinking of the resin that configures the CFRP material becomes stronger.

Regarding these test pieces Nos. 1 to 10, the cut tests were performed while changing the temperature, and the cut state of when the cut test was performed at each temperature was confirmed. As a result, the results illustrated in FIG. 17 were obtained. In FIG. 17, a result where there is less separation in the cut surface and the cut result is favorable is marked with ∘, and a result where the cut result is not favorable because separation and the like occur in the cut surface is marked with x.

As illustrated in FIG. 17, in all of test pieces Nos. 1 to 10, the cut state is poor at normal temperature. Further, when the CFRP materials are cut at the respective glass transition point temperatures, the CFRP materials can be cut with a favorable cut state. Further, it has been found out that, as a temperature at which a favorable cut state can be obtained, the favorable cut state can be obtained at a predetermined temperature range that is lower than the glass transition point temperature, in all of the test pieces. As described above, the temperature range in which a favorable cut state can be obtained is different depending on the test piece. However, in all of the test pieces, a favorable cut state can be obtained by performing the cutting within a temperature range from the temperature lower than the glass transition point temperature by 30° C. to the glass transition point temperature.

Note that, in test pieces Nos. 9 and 10, a favorable cut state can be obtained from a lower temperature to the glass transition point temperature than other test pieces. However, test pieces Nos. 9 and 10 use a special material in which a separation suppression component is combined with the resin that configures the CFRP materials. Therefore, test pieces Nos. 9 and 10 have a less separation amount than normal materials, and a region where the result of the cut state is favorable is wider.

According to these test results, it has been confirmed that physical properties such as elastic modulus and strength become suitable values in the temperature range from the temperature lower than the glass transition point temperature by 30° C. to the glass transition point temperature, and thus occurrence of separation and the like at the time of cutting the CFRP material is small, a favorable cut state can be obtained, and the temperature range is suitable for cutting the CFRP material. Therefore, in cutting the CFRP material, it is favorable to heat the CFRP material to the temperature in a cutting temperature range Rc and cut the CFRP material where a temperature range including the temperature of the glass transition point of the CFRP material, and in which the physical properties such as elastic modulus and strength become suitable values is the cutting temperature range Rc. To be specific, the cutting temperature range Rc is from the temperature lower than the glass transition point temperature by 30° C. to the temperature of the glass transition point, and it is favorable to raise the CFRP material to the temperature in the cutting temperature range Rc, and cut the CFRP material.

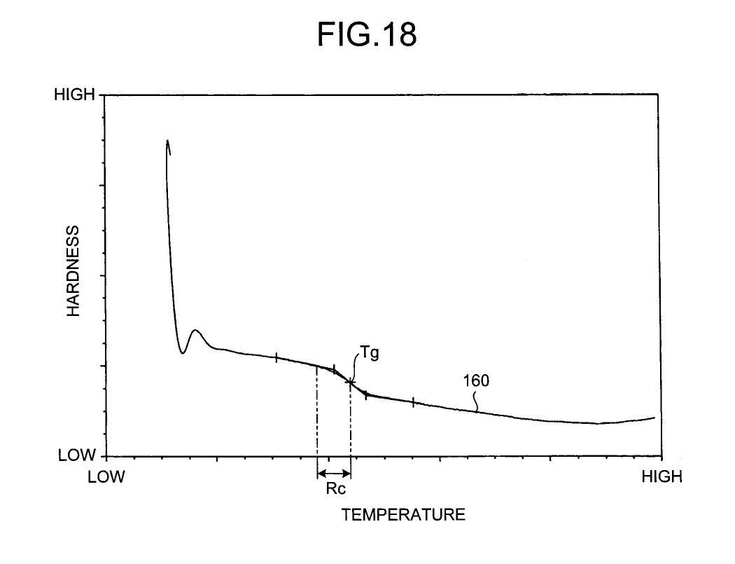

FIG. 18 is an explanatory diagram about the cutting temperature range at the time of cutting the CFRP material. Describing change of hardness 160 with respect to the temperature of the CFRP material, when the temperature of the CFRP material is raised from the normal temperature, hardness 160 is sharply decreased as the temperature rises until a predetermined temperature. Following that, hardness 160 is gently decreased with an increase of the temperature. Under this state, when the temperature of the CFRP material is continuously increased, there is a temperature range in which the degree of decrease in hardness 160 with an increase of the temperature becomes large.

To be specific, the degree of change of hardness 160 with respect to the temperature change is larger in a temperature range from the temperature of a glass transition point Tg of the CFRP material to a temperature lower than the temperature of a glass transition point Tg than cases where the temperature is lower than the temperature range, or the temperature is higher than the temperature of the glass transition point Tg. As described above, the temperature range in which the degree of change of hardness 160 with respect to the temperature change is large is the cutting temperature range Rc where the CFRP material can be cut with a favorable cut state. In this cutting temperature range Rc, the physical properties such as elastic modulus and strength become suitable values. Therefore, it is favorable to heat the CFRP material within the cutting temperature range Rc, and cut the CFRP material.

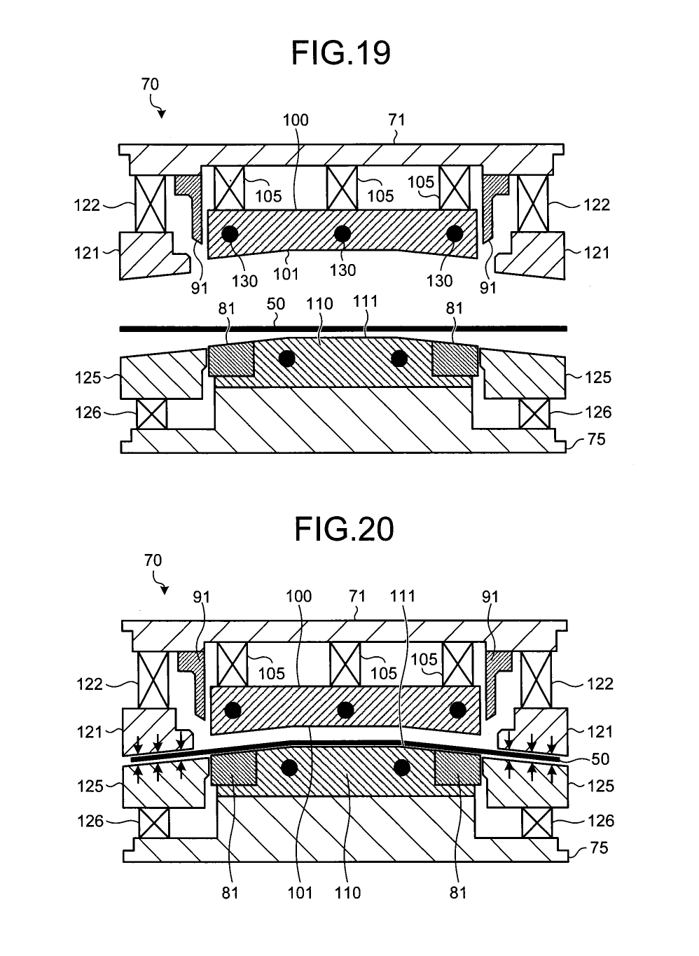

The metal mold 70 according to the second embodiment has a configuration as described above. Hereinafter, its effects and a method of manufacturing a CFRP component according to the second embodiment will be described. FIG. 19 is an explanatory diagram of before the CFRP material is molded with the metal mold illustrated in FIG. 14. When the CFRP material 50 made of a thermosetting resin is molded with the metal mold 70 according to the second embodiment, first, the temperatures of the pressing part 100 and the lower mold molding part 110 are raised by the heater 130. When the temperatures of the pressing part 100 and the lower mold molding part 110 have been raised, the lower mold molding surface 111 is covered with the CFRP material 50 in a state where the upper mold 71 is separated from the lower mold 75. To be specific, so-called prepreg, which is sheet carbon fiber impregnated with a synthetic resin, is heated by a heating device (not illustrated), and the lower mold molding surface 111 is covered with the prepreg in a high-temperature state.

FIG. 20 is an explanatory diagram of when the CFRP material illustrated in FIG. 19 is molded. The upper mold 71 is moved downward with the hydraulic pressure generated by the hydraulic pressure generator in a state where the prepreg that is the CFRP material 50 before molding is placed on the lower mold molding surface 111 of the lower mold molding part 110, so that the lower surface of the upper mold row material holding part 121 comes in contact with the upper surface of the CFRP material 50.

In this state, when the upper mold 71 is moved downward, the portion of the CFRP material 50 being in contact with the upper mold row material holding part 121 is bent toward the lower side. Accordingly, the lower surface of the CFRP material 50 comes in contact with the upper surface of the lower mold row material holding part 125, and the CFRP material 50 becomes in a state of being sandwiched by the upper mold row material holding part 121 and the lower mold row material holding part 125.

When the upper mold 71 is moved downward in the state where the CFRP material 50 is sandwiched by the upper mold row material holding part 121 and the lower mold row material holding part 125 as described above, the upper mold holding part spring 122 positioned between the upper mold row material holding part 121 and the upper mold 71 is elastically deformed and contracted, so that the energizing force to the lower side is provided from the upper mold row material holding part 121 to the CFRP material 50.

The lower mold holding part damper 126 has a length with which the upper surface side of the lower mold row material holding part 125 becomes to have the height continuous with the upper surface side of the lower mold molding part 110 and the stationary blade 81 at the time of molding the CFRP material 50. Therefore, the lower surface side of the CFRP material 50 is in contact with the lower mold row material holding part 125, and is held on the lower mold row material holding part 125. Therefore, the CFRP material 50 provided the energizing force from the upper mold row material holding part 121 becomes in a state of being sandwiched by the upper mold row material holding part 121 and the lower mold row material holding part 125 with the energizing force from the up and down direction, and is fixed by the upper mold row material holding part 121 and the lower mold row material holding part 125.

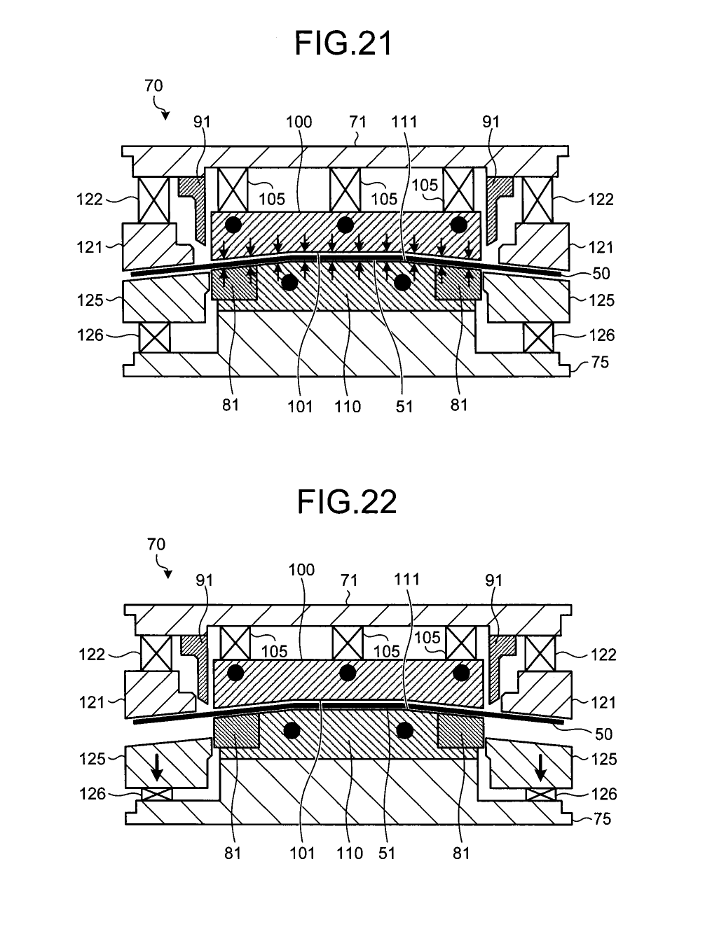

FIG. 21 is an explanatory diagram at the time of molding of the CFRP material illustrated in FIG. 20. In molding the CFRP material 50, the upper mold 71 is moved downward in a state where the CFRP material 50 is fixed by the upper mold row material holding part 121 and the lower mold row material holding part 125, so that the upper mold molding surface 101 of the pressing part 100 comes in contact with the CFRP material 50. In this state, when the upper mold 71 is further moved downward with the hydraulic pressure, and the pressure to the lower mold molding part 110 is provided from the upper mold molding surface 101 of the pressing part 100 to the CFRP material 50, so that both surfaces of the CFRP material 50 is pressurized by the upper mold molding surface 101 and the lower mold molding surface 111. Accordingly, the CFRP material 50 is deformed along the shape between the upper mold molding surface 101 and the lower mold molding surface 111. At that time, heat of the pressing part 100 and the lower mold molding part 110 is transmitted to the CFRP material 50. Therefore, in the CFRP material 50, a chemical reaction of the resin is started with the pressure provided from the upper mold molding surface 101 and the lower mold molding surface 111, and the heat transmitted therefrom. Therefore, the resin of the CFRP material 50 is cured, and is cured in a state of being deformed along the shape between the upper mold molding surface 101 and the lower mold molding surface 111. Accordingly, the portion to be molded 51 of the CFRP material 50 is molded into a desired shape.

FIG. 22 is an explanatory diagram illustrating a state in which the lower mold row material holding part illustrated in FIG. 21 is lowered. When the CFRP material 50 is cured, the lower mold holding part damper 126 is contracted, so that the lower mold row material holding part 125 is lowered. Accordingly, the lower mold row material holding part 125 is downwardly separated from the CFRP material 50, and cutting of the CFRP material 50 becomes possible.

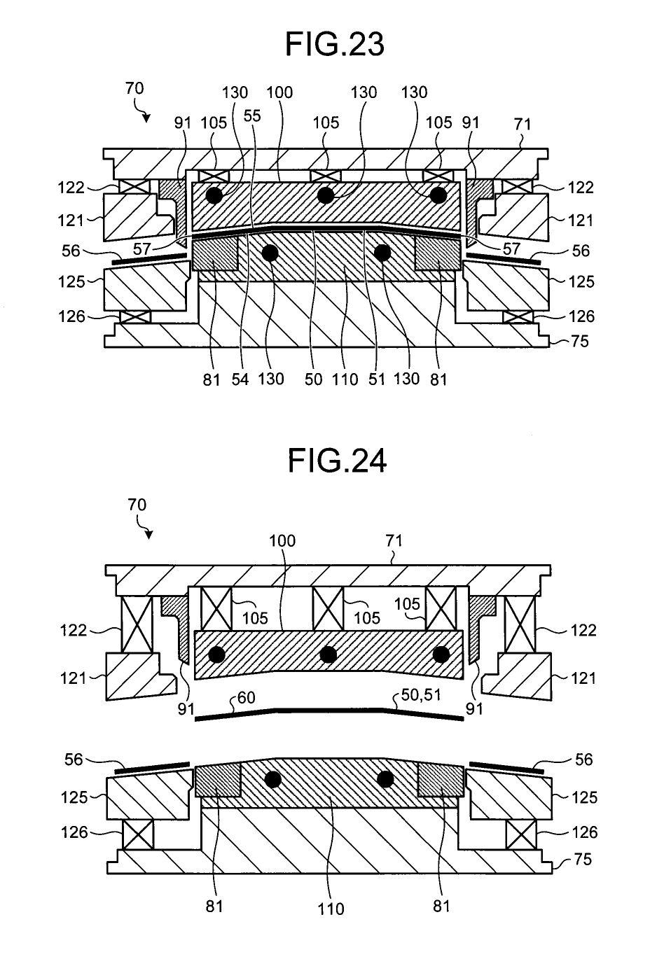

FIG. 23 is an explanatory diagram illustrating a state in which the CFRP material illustrated in FIG. 22 is cut. When the CFRP material 50 is molded and cured, and the lower mold row material holding part 125 is separated from the CFRP material 50, next, the CFRP material 50 is cut by the cutting mechanism 80. In cutting the CFRP material 50, first, the cut portion 57 of the CFRP material 50 having a high temperature is cooled to a temperature near the glass transition point of the CFRP material 50. To be specific, the temperature of the cut portion 57 is adjusted to be a temperature near the glass transition point of the synthetic resin that configures the CFRP material 50.

That is, the CFRP material 50, the temperature of which has been raised to the temperature of the glass transition point or more by the heaters 130 provided inside the pressing part 100 and the lower mold molding part 110, is cooled, so that the temperature of the cut portion 57 is decreased to fall within the range from the temperature lower than the glass transition point temperature of the CFRP material 50 by 30° C. to the glass transition point temperature. The CFRP material 50 is cut in a state where the temperature of the cut portion 57 becomes a temperature near the glass transition point of the CFRP material 50. In other words, the heater 130 can heat the temperature of the cut portion 57 of the CFRP material 50 to within the cutting temperature range Rc that includes at least the temperature of the glass transition point of the CFRP material 50, and in which the physical properties such as elastic modulus and strength become suitable values.

Note that, regarding the temperature of the cut portion 57 heated by the heater 130, the temperature at the time of cutting can be adjusted such that a control amount of an output of the heater 130 and the timing to perform cutting are obtained in advance by performing of a temperature test, and the control and cutting are performed at the obtained control amount and timing. Alternatively, a temperature sensor (not illustrated) is provided, and the output of the heater 130 and the timing to perform cutting may be adjusted while the temperature of the cut portion 57 or a peripheral temperature thereof is detected. Any technique can be employed as long as the CFRP material 50 can be cut in a state where the temperature of the cut portion 57 is raised to near the glass transition point of the CFRP material 50.

When the temperature of the cut portion 57 is raised, the upper mold 71 is moved in the direction of the lower mold 75, so that the moving blade 91 is moved in the direction of the stationary blade 81. Accordingly, the pressing part 100 is pushed to the CFRP material 50, and the pressing force to the CFRP material 50, the lower surface side of which is held by the lower mold molding part 110, becomes large. The pressing force in this case falls within the range from 3 to 10 MPa, both inclusive, similarly to the case of cutting with the metal mold 1 according to the first embodiment, and favorably falls within a range from 5 to 9 MPa, both inclusive.

In this state, the moving blade 91 is moved from the moving blade surface 55 side to the stationary blade surface 54 side at the CFRP material 50, so that the shear force is provided to the cut portion 57 of the CFRP material 50 by the moving blade 91 and the stationary blade 81. Accordingly, the CFRP material 50 is cut at the cut portion 57, and the removed portion 56 is separated from the portion to be molded 51.

FIG. 24 is an explanatory diagram of when a CFRP component after cutting is taken out. When the removed portion 56 of the CFRP material 50 is separated with the upper mold 71 and the lower mold 75, the upper mold 71 is moved upward, and the upper mold 71 is separated from the lower mold 75. Accordingly, the portion to be molded 51 of the CFRP material 50 is taken out, and the portion to be molded 51 is used as the CFRP component 60 in a post process.

The metal mold 70 according to the second embodiment includes the heater 130 that raises the temperature of the CFRP material 50. Therefore, in cutting the CFRP material 50, the metal mold 70 can cut the cut portion 57, which is a cut portion of the CFRP material 50, with a favorable cut surface state, with the stationary blade 81 and the moving blade 91. As a result, the CFRP material 50 can be easily cut.

Further, the heater 130 heats the CFRP material 50 so that the temperature of the cut portion 57 falls within the cutting temperature range Rc at the time of cutting the CFRP material 50, the cutting temperature range Rc including the temperature of the glass transition point of the CFRP material 50, and in which the physical properties such as elastic modulus and strength become suitable values. Therefore, in cutting the CFRP material 50, the CFRP material 50 can be cut without generating fuzz or interlayer separation in the cut portion. As a result, the CFRP material 50 can be easily cut.

Further, the metal mold 70 includes the upper mold molding surface 101, the lower mold molding surface 111, and the cutting mechanism 80, and after molding the CFRP material 50 with the upper mold molding surface 101 and the lower mold molding surface 111, the metal mold 70 cuts the removed portion 56 with the cutting mechanism 80. Therefore, molding to cutting can be performed by the single metal mold 70. As a result, the CFRP material 50 can be easily cut.

Further, the method of manufacturing the CFRP component 60 according to the second embodiment heats the CFRP material 50, adjusts the temperature of the cut portion 57 to fall within the cutting temperature range Rc, which includes the temperature near the glass transition point, and in which the physical properties such as elastic modulus and strength become suitable values, and then provides the shear force to the CFRP material 50 to cut the CFRP material 50. Therefore, the CFRP material 50 can be cut without generating the fuzz or interlayer separation. As a result, the CFRP material 50 can be easily cut.

Further, in the method of manufacturing the CFRP component 60 according to the second embodiment, after the CFRP material 50 is molded, the CFRP material 50 is cut by the metal mold 70, which has molded the CFRP material 50. Therefore, molding to cutting can be performed by the single metal mold 70. As a result, the CFRP material 50 can be more reliably and easily cut.

### Modification

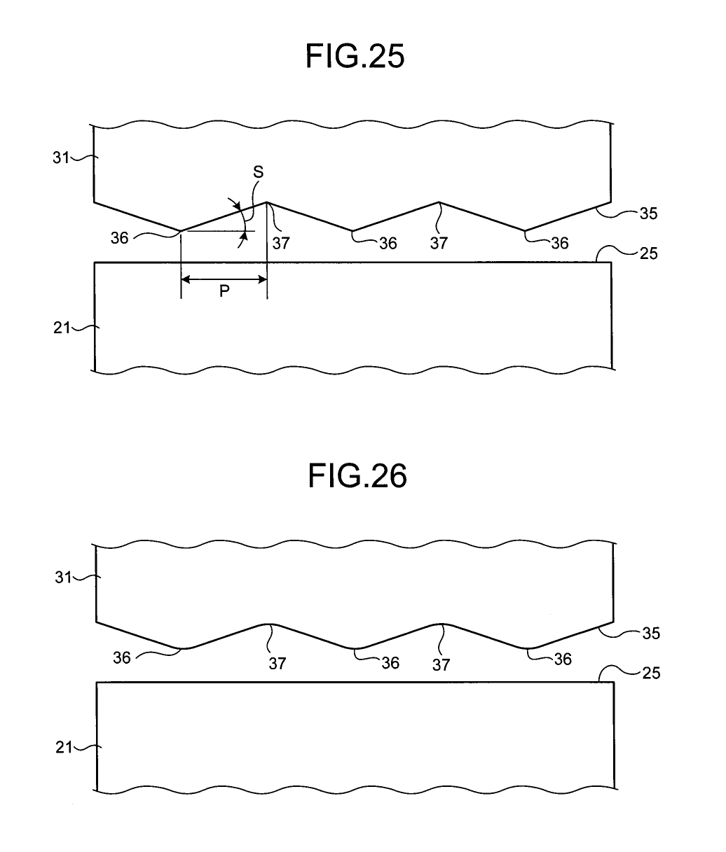

Note that, in the above metal molds 1 and 70, one mountain portion 36 is provided to one moving blade 31 and to one moving blade 91. However, a plurality of mountain portions 36 may be provided to one moving blade 31 and to one moving blade 91. FIG. 25 is a plan view of a moving blade in a modification of the metal mold according to the first embodiment. For example, a moving-side blade part 35 of a moving blade 31 is formed in a concave-convex manner, in which the distance from the moving-side blade part 35 to a stationary blade 21 is separated and gets closer as going in a horizontal direction along a stationary-side blade part 25, so that a plurality of mountain portions 36 may be formed. That is, in the moving blade 31, a valley portion 37 protruding in a direction away from the stationary blade 21 may be formed between the mountain portion 36 and the mountain portion 36, and the mountain portion 36 and the valley portion 37 may be alternately formed. Even in the case of the plurality of mountain portions 36, a shearing angle S is favorably less than 10°, and the length of the inclination in the horizontal direction along the stationary-side blade part 25, that is, a pitch P between the mountain portion 36 and the valley portion 37 is favorably within 30 cm.

When the length of the CFRP material 50 cut by the moving blade 31 and the stationary blade 21 is long, a load provided to the CFRP material 50 can be dispersed at the time of cutting with the plurality of mountain portions 36, and the CFRP material 50 can be cut at a plurality of portions. Accordingly, an amount of the moving blade 31 digging into the CFRP material 50 at the time of cutting the CFRP material 50 can be decreased, and the cut surface can be made more favorable state.

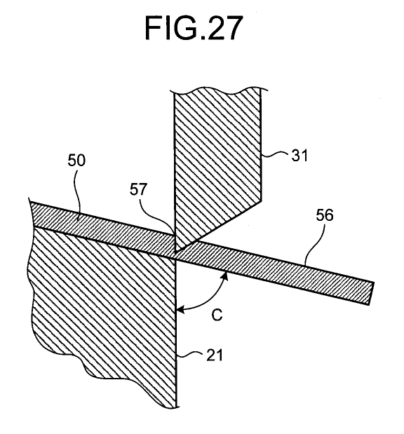

Further, the mountain portion 36 or the valley portion 37 formed in the moving-side blade part 35 of the moving blade 31 may be formed with a curved line. FIG. 26 is an explanatory diagram illustrating a modification of the moving blade of FIG. 25. The mountain portion 36 or the valley portion 37 may be formed by linking the linear blade portions positioned at both sides of the mountain portion 36 with a curved line, instead of a corner as illustrated in FIG. 26, or may be formed by linking the linear blade portions positioned at both sides of the valley portion 37 with a curved line. Further, one of the mountain portion 36 and the valley portion 37 may be formed with a curved line, and the other is formed with a corner, instead of forming both of them with a curved line. Even if the mountain portion 36 or the valley portion 37 is formed with a curved line, occurrence of separation and the like at the time of cutting the CFRP material 50 is small, and a favorable cut result can be obtained. Therefore, the mountain portion 36 or the valley portion 37 may be formed by linking the linear blade portions positioned at both sides with a curved line.

Further, in the metal mold 1 according to the first embodiment, the cutting mechanism 20 has a structure of cutting the CFRP material 50 in the vertical direction and the horizontal direction, and in the metal mold 70 according to the second embodiment, the cutting mechanism 80 has a structure to cut the CFRP material 50 in the vertical direction. However, these configurations are not limited to the first and the second embodiments. The direction into which the CFRP material 50 is cut by the metal mold 1 or 70 can be appropriately set according to the shape of the CFRP component 60.

Further, in the above metal mold 1 or 70, the cutting mechanism 20 or 80 cuts the removed portion 56 that is an unwanted part existing at a periphery of the portion to be molded 51 of the CFRP material 50. However, the cutting mechanism 20 or 80 may have a structure to cut a portion other than the unwanted part around the portion to be molded 51. For example, in performing hole processing to the portion to be molded 51, the CFRP material 50 may be cut with the shear force by the moving blade 31 or 91 and the stationary blade 21 or 81, so that the hole processing may be performed.

Further, in the above metal mold 1 or 70, the moving blade 31 or 91 is simply moved to the direction into which the distance between the moving blade 31 or 91 and the stationary blade 21 or 81 is changed, at the time of cutting the CFRP material 50. However, the moving blade 31 or 91 may provide a rotational moment to the CFRP material 50 at the time of cutting the CFRP material 50. In this way, the CFRP material 50 is cut while being provided with a rotational moment, so that a plurality of directions of loads can be provided to the CFRP material 50 at the time of cutting the CFRP material 50. Accordingly, the cut surface of the CFRP material 50 can be made more favorable state.

Further, in the above metal mold 1 or 70, the relative angle between the CFRP material 50 and the moving blade 31 or 91 at the time of cutting the CFRP material 50 is not particularly defined. However, the relative angle between the CFRP material 50 and the moving blade 31 or 91 favorably falls within a predetermined range. FIG. 27 is an explanatory diagram of a relative angle between a CFRP material and a moving blade in a modification of the metal mold according to the first embodiment. For example, the relative angle between a CFRP material 50 and a moving blade 31 are favorably defined such that the CFRP material 50 and the moving blade 31 are perpendicular to each other, or a removed portion 56 of the CFRP material 50 is slightly inclined in a direction away from the moving blade 31. To be specific, the relative angle between the CFRP material 50 and the moving blade 31 is favorably defined such that a cutting angle C that is an angle made by the removed portion 56 and a stationary blade 21 falls within a range from 75° to 90°, both inclusive.

To cause the cutting angle C to fall within the range from 75° to 90°, both inclusive, a displacement amount of the removed portion 56 side of the CFRP material 50 to fall into the stationary blade 21 at the time of cutting the CFRP material 50 can be made small. Therefore, the deformation of the CFRP material 50 at the time of cutting the CFRP material 50 can be suppressed, and a favorable cut surface can be obtained.

Further, in the above metal mold 1 or 70, the hydraulic pressure generator is used as a power source at the time of cutting or pressing the CFRP material 50. However, other power sources than the hydraulic pressure generator may be used, and for example, pressing force and the like may be generated by a gas spring or a coil spring. Any other forms may be employed regardless of the form of the power source as long as the forms can realize the above-described effects and operations. Further, the heater 130 generates heat by the heat of machine oil. However, any other forms may be employed as long as the forms can heat the CFRP material 50.

Further, regarding the metal mold 1 or 70 for the CFRP component 60, and the method of manufacturing the CFRP component 60, the configurations and the methods used in the first and the second embodiments, and the modification may be appropriately combined, or other configurations or methods than the above description may be used. The metal mold 1 or 70 for the CFRP component 60, and the configurations and methods of the method of manufacturing the CFRP component 60 can easily cut the CFRP material 50 with the shear force at the time of cutting the CFRP material 50 regardless of the above-described embodiments.

### REFERENCE SIGNS LIST

1 and 70 METAL MOLD
4 and 71 UPPER MOLD
10 and 75 LOWER MOLD
11 LOWER MOLD APPLICATION PART
20 and 80 CUTTING MECHANISM
21 and 81 STATIONARY BLADE
31 and 91 MOVING BLADE
32 UPPER MOLD-SIDE MOVING BLADE
33 LOWER MOLD-SIDE MOVING BLADE
36 MOUNTAIN PORTION
40 and 100 PRESSING PART (PRESSING MEANS)
41 UPPER MOLD PRESSING PART
42 APPLICATION PART PRESSING PART
50 CFRP MATERIAL (MATERIAL TO BE PROCESSED)
51 PORTION TO BE MOLDED
54 STATIONARY BLADE SURFACE
55 MOVING BLADE SURFACE
56 REMOVED PORTION
57 CUT PORTION
60 CFRP COMPONENT
101 UPPER MOLD MOLDING SURFACE (MOLDING PART)
110 LOWER MOLD MOLDING PART
111 LOWER MOLD MOLDING SURFACE (MOLDING PART)
130 HEATER (HEATING MEANS)

1. A metal mold for a carbon fiber reinforced plastic component, comprising:
a stationary blade that is a blade standing still in contact with one surface of a material to be processed made of a carbon fiber reinforced plastic;
a moving blade arranged at a moving blade surface side of the material to be processed, the moving blade surface being a surface opposite to a stationary blade surface, the stationary blade surface being a surface at a side where the stationary blade is positioned, and adapted to cut the material to be processed by being moved from the moving blade surface side to the stationary blade surface side and providing shear force to the material to be processed together with the stationary blade;
a heating unit adapted to heat the material to be processed to raise a temperature of a cut portion in the material to be processed; and
a pressing unit adapted to provide pressing force in a moving direction of the moving blade to the material to be processed,
wherein, at the time the carbon fiber reinforced plastic is a thermosetting resin, the heating unit heats the cut portion in the material to be processed to be within a temperature range including a temperature of a glass transition point of the thermosetting resin, and in which a physical property of the material to be processed becomes to have a suitable value for heating, and
the pressing unit provides the pressing force to the material to be processed at a time of cutting the material to be processed within a range from 3 to 10 MPa, both inclusive.

2-6. (canceled)

7. The metal mold for the carbon fiber reinforced plastic component according to claim 1, further comprising:
a molding part adapted to mold the material to be processed by providing the pressing force to the material to be processed,
wherein, after the material to be processed is molded by the molding part, the moving blade cuts the material to be processed together with the stationary blade.

8. A method of manufacturing a carbon fiber reinforced plastic component, the method comprising:
at the time cutting a material to be processed made of a carbon fiber reinforced plastic as a thermosetting resin by heating the material to be processed to raise a temperature of a cut portion in the material to be processed, and providing shear force to the material to be processed in a thickness direction,
performing the cutting of the material to be processed in a state where the temperature of the cut portion in the material to be processed is increased to be within a temperature range including a temperature of a glass transition point of the thermosetting resin, and in which a physical property of the material to be processed becomes to have a suitable value for heating, and further in a state where pressing force is provided to the material to be processed in a direction providing the shear force within a range from 3 to 10 MPa, both inclusive.

9-13. (canceled)

14. The method of manufacturing the carbon fiber reinforced plastic component according to claim 8, the method further comprising:
a process of molding the material to be processed by providing the pressing force to the material to be processed,
wherein, after the material to be processed is molded, the cutting of the material to be processed is performed by a metal mold that has molded the material to be processed.
